(19) United States
(12) Patent Application Publication
(10) Pub. No.: US 2023/0088055 A1
(43) Pub. Date: Mar. 23, 2023

(54) THREE DIMENSIONAL STRATIGRAPHIC MODELS THAT BEST EXPLAIN MEASURED LOGS BY LEVERAGING VECTOR QUANTIZATION VARIATIONAL AUTOENCODER AND DATA CLUSTERING

(71) Applicant: Schlumberger Technology Corporation, Sugar Land, TX (US)

(72) Inventors: Peter Tilke, Watertown, MA (US); Wyame Benslimane, Clamart (FR); Lingchen Zhu, Medford, MA (US); Zikri Bayraktar, Wilmington, MA (US)

(21) Appl. No.: 17/933,506

(22) Filed: Sep. 20, 2022

Related U.S. Application Data
(60) Provisional application No. 63/246,130, filed on Sep. 20, 2021.

(51) Int. Cl. G01V 1/28; G01V 1/30

(52) U.S. Cl. CPC G01V 1/282; G01V 1/30; G01V 2210/66

(57) ABSTRACT

Methods and platforms for allowing efficient identification of 3D stratigraphic models that explain observed log data.

### CROSS-REFERENCE TO RELATED APPLICATIONS

The present application claims priority to U.S. Provisional Patent Application 63/246,130 filed Sep. 20, 2021, the entirety of which is included by reference.

### FIELD OF THE DISCLOSURE

Aspects of the disclosure relate to modeling of geological structures. More specifically, aspects of the disclosure relate to three dimensional stratigraphic models that explain well logging data for drilling and measurement acquisition decisions by operators.

### BACKGROUND INFORMATION

Well log data is often used to assist with field development and reservoir management; however, 3D stratigraphic models are often needed help to explain observations of the obtained data.

While log data is used within three dimensional models, conventional methods of using models has several drawbacks. These drawbacks include relative inaccuracy of the model and prohibitive cost.

Therefore, there is a need for a platform and method of finding geologically realistic 3D stratigraphic models from a model library given some observed measurement logs.

There is a further need to provide such modeling capabilities that are economical compared to conventional apparatus.

There is a further need to provide modeling capabilities that are more accurate than conventional attempts at modeling.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method of providing a plurality of three-dimensional models is disclosed. The method may include generating a plurality of three-dimensional stratigraphic models and inputting the three-dimensional stratigraphic models into a library. The method may also include establishing a connection between a vector quantization variable autoencoder engine with the library and providing data to the vector quantization variable autoencoder engine. The method may also comprise identifying three dimensional stratigraphic models explaining the data and ranking models in the library and providing a listing of models based upon the ranked models in the library.

In another example embodiment, a method may be performed for providing an optimized well trajectory for a plurality of three-dimensional models, comprising generating a plurality of three-dimensional stratigraphic models and inputting the three-dimensional stratigraphic models into a library. The method may also provide for establishing a connection between a vector quantization variable autoencoder engine with the library and providing data to the vector quantization variable autoencoder engine.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 depicts an embodiments of the method, according to one or more embodiments.

FIG. 2 is an embodiment of VQ-VAE encoder and decoder architecture according to an embodiment of the disclosure.

FIG. 3 depicts VAE encoding and reconstruction performance according to an embodiment of the disclosure.

FIG. 4 depicts VQ-VAE encoding and reconstruction performance according to an embodiment of the disclosure.

FIG. 5 depicts query results according to an embodiment of the disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

There is a significant need for exploration and field development workflows to obtain 3D stratigraphic models that can explain well log data for drilling and measurement acquisition decisions. The disclosed methods and platforms meet this objective, i.e., locate the ensemble of 3D stratigraphic models that can explain observations. The disclosed platform has a plurality of 3D stratigraphic models spanning a spectrum of depositional environments stored in a datastore. This datastore models have encoded indexes of well log signatures. This encoding is achieved using the Vector Quantization Variational Autoencoder (VQ-VAE) approach. User supplied well logs are also encoded with VQ-VAE to allow fast search in this datastore based on a clustering algorithm.

Finding geologically realistic 3D stratigraphic models from a model library given some observed measurement logs is an essential step for field development and reservoir management because these 3D sedimentary facies architecture and connectivity play a critical role in the determination of reservoir heterogeneity and hydrocarbon flow.

The disclosed system stores a plurality of 3D stratigraphic models in a library of models. The 3D stratigraphic models can be built using a specially designed physics-based stratigraphic forward modeler, with different petrophysical and rock facies configurations and random seeds. With the help of high-performance computing that parallelly spans a spectrum of deposition and facies configurations, the platform can populate hundreds or thousands of 3D stratigraphic models in a reasonable amount of time, and store them in this model library X.

The individual 3D stratigraphic models in the library are represented as ZGY files at different spatial resolutions. For example, 0.1 m vertical resolution is suitable for vertical wells. Well logs in the form of time-series signals can be extracted from X for all models at all possible well positions and they are stored in LAS format. Suppose each model in X is of size N×N, then N² well logs can be populated. Each well log is denoted as x=[x₀, . . . , x_{L-1}]∈X where L is the length of well logs.

The method of searching the library includes using a tool that accepts a well log acquired in the field from logging tools, and returns 3D stratigraphic models from the library along with the locations within those models that best explain the supplied well log(s).

The number of original logs from the model library is abundant and logs from nearby locations can be quite similar. To ensure efficient model search and diversified retrieval results, the disclosed methods leverage a clustering methodology. Due to dimensionality, any clustering method prefers all high-dimensional input data to be encoded into a low-dimensional domain for better cluster separations. The disclosed method employs a Vector Quantization Variational Autoencoder (VQ-VAE) for dimensionality reduction because it provides better encoding and decoding performance than the vanilla Variational Autoencoder (VAE).

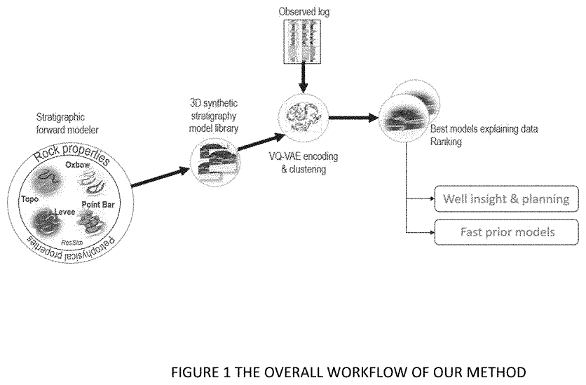

FIG. 1 shows the overall workflow of one example method embodiment of the disclosure. All well logs from the model library are encoded to the low-dimensional domain by the VQ-VAE encoder, and then clustered by the k-means algorithm. Each cluster is represented by the cluster centroid which is also called the key encoded well log. The supplied query log is also encoded by VQ-VAE and used to find the top-N clusters this encoded log matches. After finding the top-N matched cluster centroid indices, these well locations as well as the model(s) they belong to are then recovered from the model library.

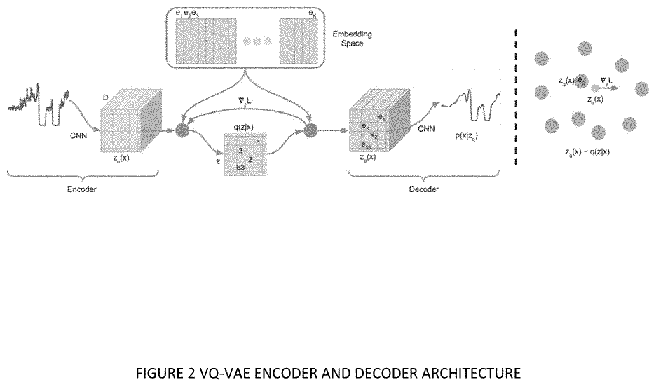

Both VQ-VAE and VAE share the same encoder-decoder architecture such that the encoder compresses an input x to a latent vector z=f(x) and the decoder reconstructs the original input \tilde{x}=g(z) to its best extent. f and g are the deep neural networks for encoder and decoder, respectively. From a probabilistic point of view, the encoder learns a Bayesian posterior distribution q(z|x) and the decoder learns the conditional distribution p(x|z). That means all compressed latent vectors z from the training data x˜p(x) can be regarded as sampled from q(z|x). The fundamental difference between VQ-VAE and VAE is that VAE learns a continuous Gaussian posterior distribution q(z|x) and defines a static prior distribution p(z); while VQ-VAE learns a discrete distribution q(z|x) and does not assume anything on p(z), as shown in FIG. 2. VQ-VAE extends the VAE by adding a trainable discrete codebook e=[e₁, . . . , e_{K}]∈ [symbol] ^{D×K} to serve as p(z), where K is the size of the latent space and D is the dimensionality of each latent vector eᵢ, i=1, . . . , K. The posterior distribution q(z|x) of VQ-VAE are defined as one-hot categorical distribution as follows:

$$q ( z = k \vert x ) = \{ \begin{matrix}1 , for k = arg {min}_{j} {‖ {z}_{e} ( x ) - {e}_{j} ‖}_{2} \\ 0 , otherwise\end{matrix} \qquad ( 1 )$$

where zₑ(x) is the output of the encoder neural network. Equation (1) assigns the index of the codebook vector that is closest to the encoder output. To reconstruct \tilde{x}, VQ-VAE translates each integer index q(z=k|x) with z_{q}(x)=eₖ and then feeds such vector to the decoder neural network to reconstruct \tilde{x}. Since both neural network weights and codebook vectors are trainable, VQ-VAE applies an alternating optimization method. When neural networks of encoder and decoder are trained, the codebook is frozen; when the codebook is updated with the vector quantization algorithm, both neural networks are frozen.

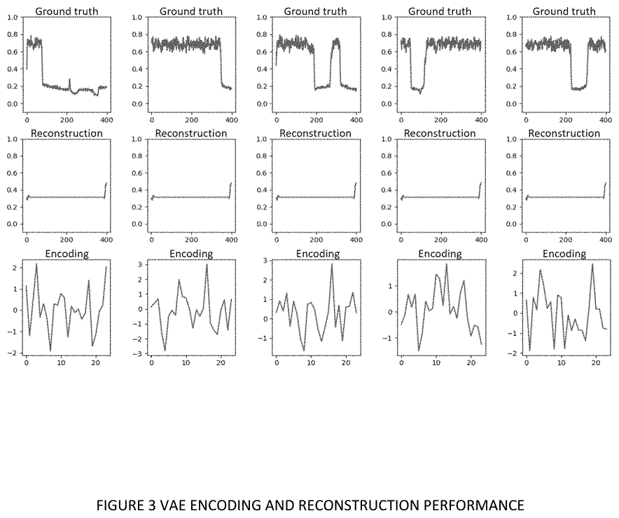

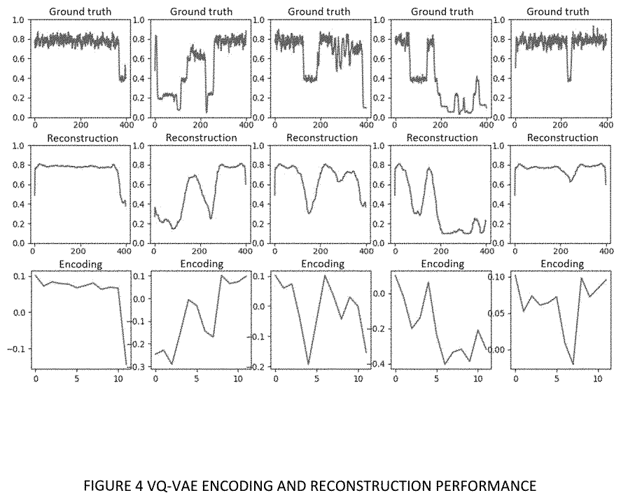

Based on our experiments, VQ-VAE can achieve higher compression rate, easier to separate —separable clusters and still preserves a better reconstruction performance than VAE when applying on the well logs. FIG. 3 and FIG. 4 compare the encoding the reconstruction performance of VAE and VQ-VAE, respectively, on a few noisy gamma ray logs. The first rows of both figures are the original input noisy gamma ray logs. The second rows are the reconstructed gamma ray logs decoded from the encoded latent vectors shown on the third rows. It can be seen that VAE failed to reconstruct them when the compression ratio is 16, i.e., the length of well logs L=400 and the dimension of encoded latent vectors is 25. On the contrary, VQ-VAE can reconstruct all of them pretty well. Not only the stationary low-frequency components in the logs are well recovered, those high-frequency step changes are also maintained. Such a performance superiority is achieved because VQ-VAE can embed all sorts of rich information from the training set to its codebook, and thus it provides a stronger representation capability on the latent vectors.

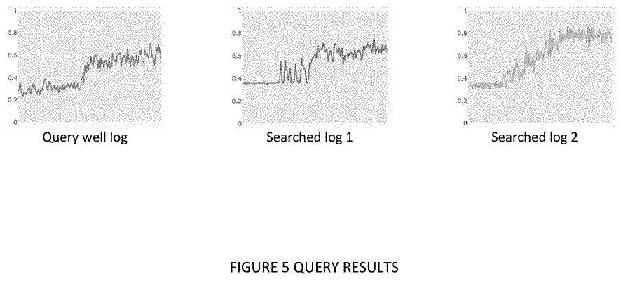

FIG. 5 shows an actual query operation given a query well log from offshore Wheatstone field, Western Australia. Its latent vector encoded by VQ-VAE is then used to find the top-2 closest cluster centroids of all well logs in the model library. I can also be seen that the searched centroids, after decoded to the original time-series signal domain, look pretty similar to the provided query log. They represent two actual cluster centroids in the model library and hence their locations and the corresponding model attributes, such as depofacies and petrophysical rock properties configurations are all revealed.

The disclosed methods and platform provide a search framework to locate 3D stratigraphic models that best explain the provided well log from a predefined model library. The disclosed methods search well logs by finding the mostly matched clusters in a compressed domain encoded by VQ-VAE.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

In one example embodiment, a method of providing a plurality of three-dimensional models is disclosed. The method may include generating a plurality of three-dimensional stratigraphic models and inputting the three-dimensional stratigraphic models into a library. The method may also include establishing a connection between a vector quantization variable autoencoder engine with the library and providing data to the vector quantization variable autoencoder engine. The method may also comprise identifying three dimensional stratigraphic models explaining the data and ranking models in the library and providing a listing of models based upon the ranked models in the library.

The method may also be conducted wherein the library is a computer-based model library.

In another example embodiment, the method may be performed wherein the providing the data to the vector quantization variable autoencoder engine is from the model library.

In another example embodiment, the method may be performed wherein the providing the data to the vector quantization variable autoencoder engine is log data.

In another example embodiment, the method may be performed wherein the listing of the models is based upon well insight.

In another example embodiment, the method may be performed wherein the listing of the models is based upon wellbore planning.

In another example embodiment, the method may be performed wherein the listing of the models is based upon prior models.

In another example embodiment, a method may be performed for providing an optimized well trajectory for a plurality of three-dimensional models, comprising generating a plurality of three-dimensional stratigraphic models and inputting the three-dimensional stratigraphic models into a library. The method may also provide for establishing a connection between a vector quantization variable autoencoder engine with the library and providing data to the vector quantization variable autoencoder engine.

The method may also provide for identifying three dimensional stratigraphic models explaining the data and ranking the models in the library according to at least one of an optimized well trajectory to be placed in each of the models and an optimal wellbore location in each of the models.

In another example embodiment, the method may be performed wherein the library is a computer-based model library.

In another example embodiment, the method may be performed wherein the providing the data to the vector quantization variable autoencoder engine is from the model library.

In another example embodiment, the method may be performed wherein the providing the data to the vector quantization variable autoencoder engine is log data.

In another example embodiment, the method may be performed wherein the library is stored at least on one of a computer server and an internet cloud.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A method of providing a plurality of three-dimensional models, comprising:
generating a plurality of three-dimensional stratigraphic models;
inputting the three-dimensional stratigraphic models into a library;
establishing a connection between a vector quantization variable autoencoder engine with the library;
providing data to the vector quantization variable autoencoder engine;
identifying three dimensional stratigraphic models explaining the data and ranking models in the library; and
providing a listing of models based upon the ranked models in the library.

2. The method according to claim 1, wherein the library is a computer-based model library.

3. The method according to claim 1, wherein the providing the data to the vector quantization variable autoencoder engine is from the model library.

4. The method according to claim 1, wherein the providing the data to the vector quantization variable autoencoder engine is log data.

5. The method according to claim 1, wherein the listing of the models is based upon well insight.

6. The method according to claim 1, wherein the listing of the models is based upon wellbore planning.

7. The method according to claim 1, wherein the listing of the models is based upon prior models.

8. A method of providing an optimized well trajectory for a plurality of three-dimensional models, comprising:
generating a plurality of three-dimensional stratigraphic models;
inputting the three-dimensional stratigraphic models into a library;
establishing a connection between a vector quantization variable autoencoder engine with the library;
providing data to the vector quantization variable autoencoder engine;
identifying three dimensional stratigraphic models explaining the data; and
ranking the models in the library according to at least one of an optimized well trajectory to be placed in each of the models and an optimal wellbore location in each of the models.

9. The method according to claim 8, wherein the library is a computer-based model library.

10. The method according to claim 8, wherein the providing the data to the vector quantization variable autoencoder engine is from the model library.

11. The method according to claim 8, wherein the providing the data to the vector quantization variable autoencoder engine is log data.

12. The method according to claim 8, wherein the library is stored at least on one of a computer server and an internet cloud.
